(19) United States
(12) Patent Application Publication
(10) Pub. No.: US 2017/0290037 A1
(43) Pub. Date: Oct. 5, 2017

(54) COEXISTENCE METHODS AND APPARATUS FOR SHARING CHANNELS

(71) Applicant: QUALCOMM Incorporated, San Diego, CA (US)

(72) Inventors: Satashu GOEL, San Diego, CA (US); Farhad MESHKATI, San Diego, CA (US); Damanjit SINGH, San Diego, CA (US); Mostafa KHOSHNEVISAN, San Diego, CA (US); Douglas KNISELY, Seattle, WA (US); Mehmet YAVUZ, San Diego, CA (US); Christophe CHEVALLIER, San Diego, CA (US)

(21) Appl. No.: 15/476,532

(22) Filed: Mar. 31, 2017

Related U.S. Application Data
(60) Provisional application No. 62/318,757, filed on Apr. 5, 2016.
(60) Provisional application No. 62/319,217, filed on Apr. 6, 2016.

(51) Int. Cl. H04W 72/12; H04W 72/10; H04W 72/08

(52) U.S. Cl. CPC H04W 72/1215; H04W 72/082; H04W 72/10

(57) ABSTRACT

Coexistence solutions may be needed for sharing channels with multiple operators. In an aspect of the disclosure, a method, a computer-readable medium, and an apparatus for sharing channels with multiple operators are provided. The apparatus may detect a conflict between a first base station and a second base station based on a coverage overlap between the first base station and the second base station. The apparatus may resolve the conflict based on a classification of the conflict, and at least one of a channel priority or a channel preference.

### CROSS-REFERENCE TO RELATED APPLICATIONS

This application claims the benefit of U.S. Provisional Application Ser. No. 62/318,757, entitled “COEXISTENCE METHODS AND APPARATUS FOR SHARING CHANNELS” and filed on Apr. 5, 2016, and U.S. Provisional Application Ser. No. 62/319,217, entitled “COEXISTENCE METHODS AND APPARATUS FOR SHARING CHANNELS” and filed on Apr. 6, 2016, which are expressly incorporated by reference herein in its entirety

### BACKGROUND

### Field

The present disclosure relates generally to communication systems, and more particularly, to coexistence solutions for sharing channels with multiple operators.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

Shared channels are used for General Authorized Access (GAA) operation in 3.5 GHz. There may be more operators than the number of channels, either due to large number of operators, or due to few channels being available because incumbents have taken most of the channels. Therefore, the same channel may be used by multiple operators. Coexistence solutions may be desirable for sharing channels with multiple operators.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication are provided. The apparatus may detect a conflict between a first base station and a second base station based on a coverage overlap between the first base station and the second base station. The apparatus may resolve the conflict based on a classification of the conflict, and at least one of a channel priority or a channel preference.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 is a diagram illustrating an example of channel reshuffling.

FIG. 5 is a flowchart of a method of wireless communication.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a conceptual data flow diagram illustrating the data flow between different means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

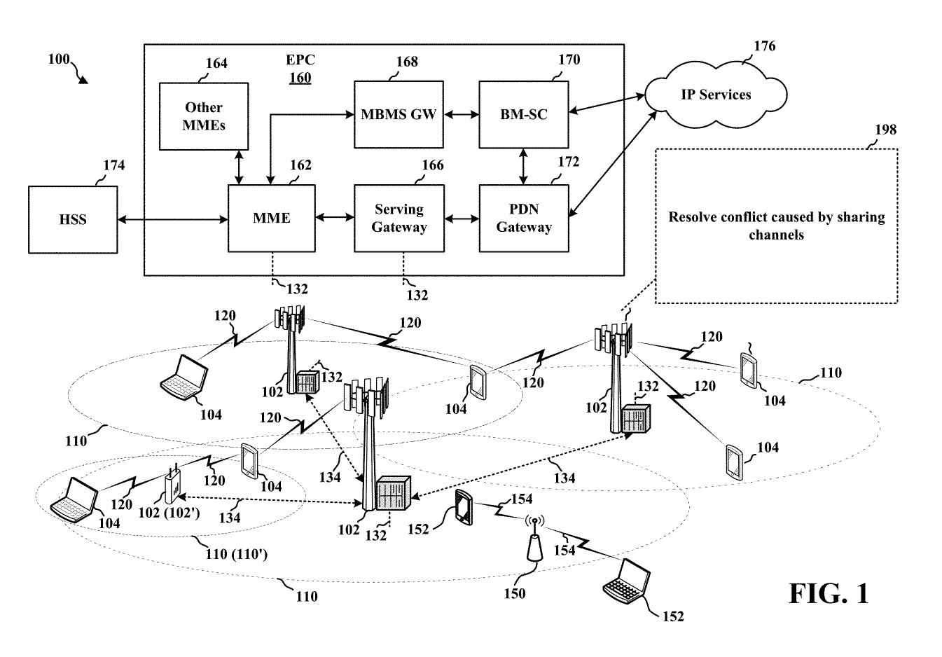

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

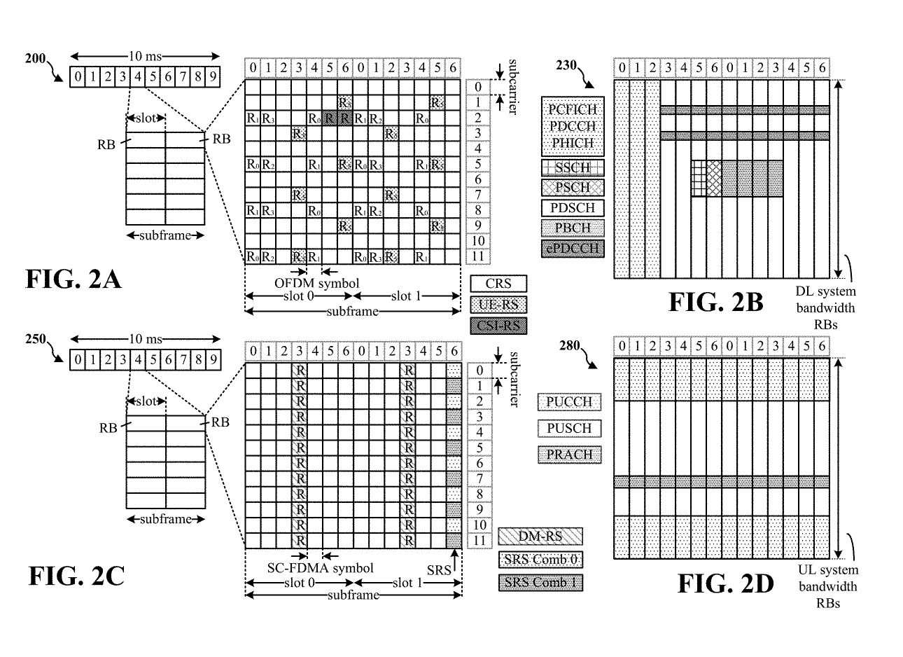

Referring again to FIG. 1, in certain aspects, the eNB 102 may be configured to resolve (198) conflict caused by sharing channels. The operations performed at 198 are described below in more details with reference to FIGS. 2-11.

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

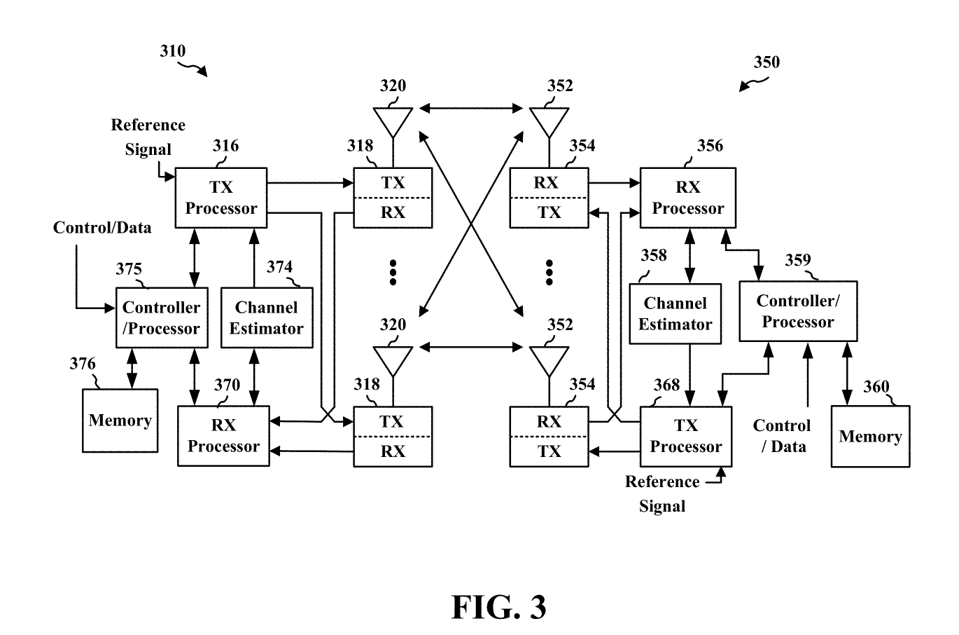

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each sub carrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In a wireless communication system, a coexistence solution may need to identify conflict between nodes (e.g., eNBs) operated by different operators. The conflict may arise due to interference from a neighboring node operated by another operator. The conflict may be a co-channel conflict or an adjacent channel conflict. The coexistence solution may need to perform conflict resolution on conflicting nodes. Examples of the actions taken during conflict resolution may include one or more of changing channel allocation, changing TDD configuration, or changing transmit power limit.

With LTE operation, either UL operation or DL operation or both, may be impacted due to interference from a neighboring node. Impact could be due to the proximity of nodes or UEs, TDD configuration mismatch (e.g., UL transmission in one cell occurring during DL transmission in a neighboring cell), non-synchronization of time, and same or adjacent channel allocation. Therefore, there is a need for the co-existence of LTE operations by one node with operations by another node when the two nodes have overlapping RF coverage.

If one node operates with a time-division-duplexed radio access technology, e.g., LTE-TDD (LTE-TDD is a mode of the LTE standard specified for unpaired spectrum, each of which is used for both transmitting and receiving), and a neighboring node operates with a listen-before-talk (LBT) related technology (LTE based LBT related technologies (LTE-LBT) include MulteFire, LAA, and enhanced LAA (eLAA)), the LTE-LBT node may not be able to access a channel due to interference caused by the LTE-TDD operations. Similarly, the performance of the LTE-TDD system may be degraded due to time-varying interference caused by the LTE-LBT node. Therefore, there is a need for the co-existence of an LTE-TDD node with LTE-LBT operations by a neighboring node.

If two or more nodes operate on the same or adjacent channels such that the two or more nodes serve different groups of users and cause performance degradation (in uplink transmissions or downlink transmissions) on at least one node due to simultaneous operations, the conflict may be identified, and if possible, the cause of conflict (e.g., co-channel, adjacent-channel, LTE-TDD-LTE-TDD, LTE-TDD-LTE-LBT, TDD configuration mismatch, etc.) may be classified. Additionally, conflict resolution may be performed so that simultaneous operations by the two or more nodes result in no performance degradation or acceptable performance degradation. In the following text, LTE refers to LTE-TDD and, for simplicity, MulteFire is used just as an example of an LTE-LBT technology.

In one configuration, Node B may overlap with Node A if Node B's signal level detected at Node A is stronger than Z dBm, or if x % of UEs served by Node A see a Node B signal level within Y dB of Node A's signal level measured by each UE served by Node A, or if the UL signal level from Node B UEs at Node A is higher than T dBm. In one configuration, different thresholds may be chosen for co-channel interference vs adjacent channel interference (as well as whether transmissions are time synchronized or asynchronous). Note that RF coverage overlap may be defined in terms of measurements at the eNB (via network listening), measurements at the UE, or a combination of both. In case of TDD configuration misalignment, definition of overlapping coverage may additionally include eNB DL to eNB UL interference and UE UL to UE DL interference. Node B and Node A may be operating on the same channel (co-channel) or on adjacent channels. The impact of interference may be captured in both the co-channel and adjacent channels cases to define overlap. Prior to starting operation, RF coverage overlap may be estimated based on location information for Node B and Node A.

Co-channel conflict may refer to two nodes, where each node is from a different network/operator, with co-channel overlapping RF coverage when each node is operating on the same channel. Adjacent channel conflict may refer to two nodes from different networks/operators with adjacent channel overlapping RF coverage when one node is operating on a channel that is adjacent to the channel the other node is operating on.

Available GAA channels may be divided into LTE-preferred channels and MulteFire-preferred channels. Available GAA channels may be further divided into indoor-preferred channels and outdoor-preferred channels. The division of channels may be dynamic based on deployment density, business arrangements, deployment environment (residential/venue), etc.

Spectrum Access System (SAS) or Coexistence Manager may provide a prioritized list of channels (even within indoor/outdoor preferred channels, LTE/MulteFire preferred channels) to assist with convergence of distributed coexistence algorithms (e.g., distributed channel selection). For example, for two nodes with potential to conflict, Node A may be provided channels (in priority order) (F1, F2), while Node B may be provided channels (F2, F1).

In one configuration, there is a preference for the outdoor preferred channels to be non-adjacent. In one configuration, a node is assigned to a channel where there is no conflict with another node from a different network. If multiple conflict-free channels are available, a node is assigned to a channel on which the node has priority (e.g., an indoor-preferred channel is assigned to an indoor node). Note that channel assignment may depend on co-channel and adjacent-channel interference, and TDD configuration mismatch. If no conflict-free channel is available, conflict resolution may be performed. The key to determining conflict may be to determine overlapping coverage.

If two nodes, each node from a different network, are in conflict, one of the two nodes may be prioritized for operation over the other node. In one configuration in which one node is an indoor node and the other node is an outdoor node, if the channel having a conflict is an indoor preferred channel, the indoor node may be prioritized for conflict resolution. In one configuration in which one node is an indoor node and the other node is an outdoor node, if the channel under conflict is an outdoor preferred channel, the outdoor node may be prioritized for conflict resolution.

In one configuration in which both nodes are indoor nodes, the node which was operational first may be prioritized. In one configuration in which both nodes are indoor nodes, one node may be picked randomly or based on coverage area to be prioritized. In one configuration in which both nodes are outdoor nodes, the node which was operational first may be prioritized. In one configuration in which both nodes are outdoor nodes, one node may be picked randomly or based on coverage area to be prioritized.

In one configuration in which one node is an LTE node and the other node is a MulteFire node, if channel under conflict is MulteFire preferred, the MulteFire node may be prioritized in conflict resolution. In one configuration in which one node is an LTE node and the other node is a MulteFire node, if the channel having a conflict is LTE preferred, the LTE node may be prioritized in conflict resolution.

In one configuration in which both nodes are LTE nodes, the node which was operational first may be prioritized. In one configuration in which both nodes are LTE nodes, one node may be picked randomly or based on coverage area to be prioritized.

In one configuration in which both nodes are MulteFire nodes, the node which was operational first may be prioritized. In one configuration in which both nodes are MulteFire nodes, one node may be picked randomly or picked based on priority of the coverage area of the node.

In one configuration, if the conflict is due to adjacent channel coverage overlap, channels may be re-shuffled to remove the conflict. By re-allocating channels to nodes on adjacent channels (e.g., by re-assigning channels such that the adjacent channels that had interference are no longer adjacent), adjacent-channel interference may be reduced and a new node may be allowed to operate. If the conflict is due to TDD misalignment, the lower priority node in conflict may change its TDD timing/configuration to resolve the conflict. If the conflict still exists, the lower priority node in conflict may lower its transmit power to resolve the conflict. If the conflict still exists, the lower priority node may be stopped from operation on the channel causing the conflict.

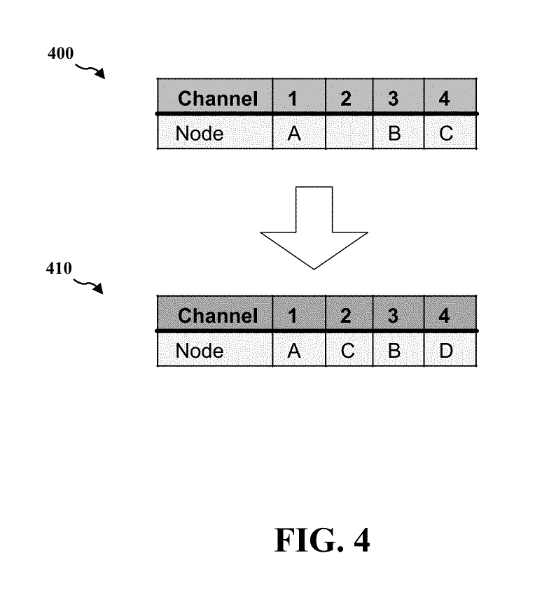

FIG. 4 is a diagram illustrating an example of channel reshuffling. In this example, four channels are available: channel 1, 2, 3, 4. Nodes A and B are outdoor nodes and Node C is an indoor node. Based on the RF environment, Nodes A, B, and C are allocated with channels as shown in diagram 400, in which Nodes A and B are separated by a channel since they are both outdoor nodes.

Suppose, now Node D arrives and needs to be allocated a channel. Node D has co-channel conflict with Nodes A, B, and C and adjacent channel conflict with Node A. Clearly, Node D cannot be allocated any channel. If Node C can be allocated channel 2, Node D can be allocated channel 4. Then, the final allocation is as shown in diagram 410. Moving Node C from channel 4 to channel 2 to accommodate a new conflict may be referred to as channel reshuffling.

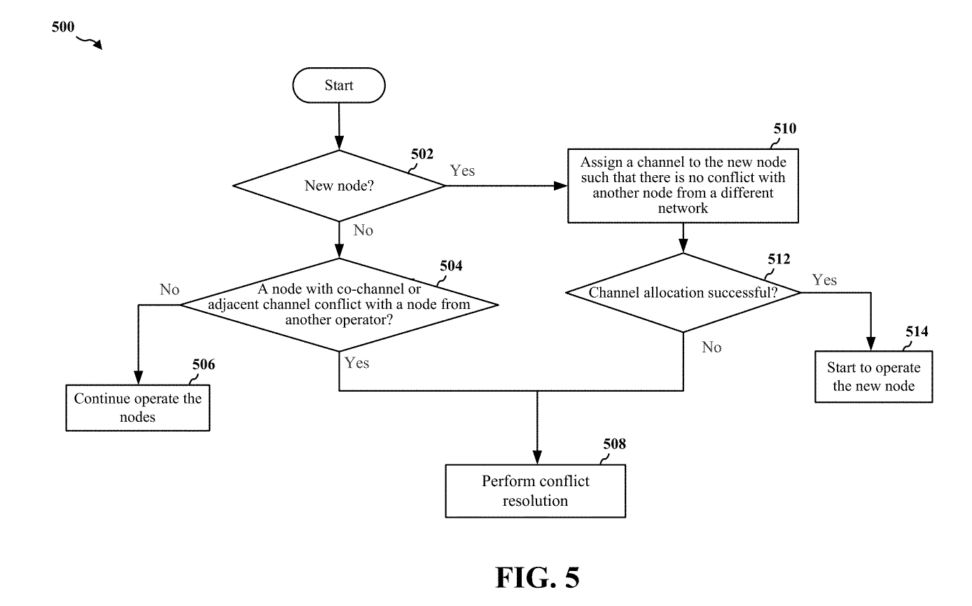

FIG. 5 is a flowchart 500 of a method of wireless communication. Specifically, the flowchart 500 describes a coexistence solution for sharing channels. In one configuration, the method may be performed by an eNB (e.g., the eNB 102, 310, or the apparatus 1002/1002′). In one configuration, the method may be performed by one of the nodes in conflict. In one configuration, the method may be performed by a central entity such as a SAS or a Coexistence Manager. In one configuration, the method may be performed in a distributed manner. In one configuration, the method may be triggered to evaluate coexistence e.g., triggered when a new node is added, triggered when the power/channel at a node changes, or triggered periodically.

At 502, the method may determine whether there is a new node in the system. In one configuration, the method may determine that there is a new node in the system after receiving a message from the new node or detecting a signal from the new node. If there is a new node, the method may proceed to 510. If there is no new node, the method may proceed to 504.

At 504, the method may determine whether there is a node with co-channel or adjacent channel conflict with a node from another operator. In one configuration, Node B may overlap with Node A if Node B's signal level detected at Node A is stronger than Z dBm, or if x % of UEs served by Node A see a Node B signal level within Y dB of Node A's signal level measured by each UE served by Node A, or if the UL signal level from Node B UEs at Node A is higher than T dBm. If there is such a conflict, the method may proceed to 508. If there is no such conflict, the method may proceed to 506.

At 506, the method may continue to operate the nodes.

At 510, the method may assign a channel to the new node such that there is no conflict with another node from a different network.

At 512, the method may determine whether the channel allocation performed at 510 is successful. In one configuration, the channel allocation is successful if the new node does not have conflict with anode node from a different network. If the channel allocation is successful, the method may proceed to 514. If the channel allocation is unsuccessful, the method may proceed to 508.

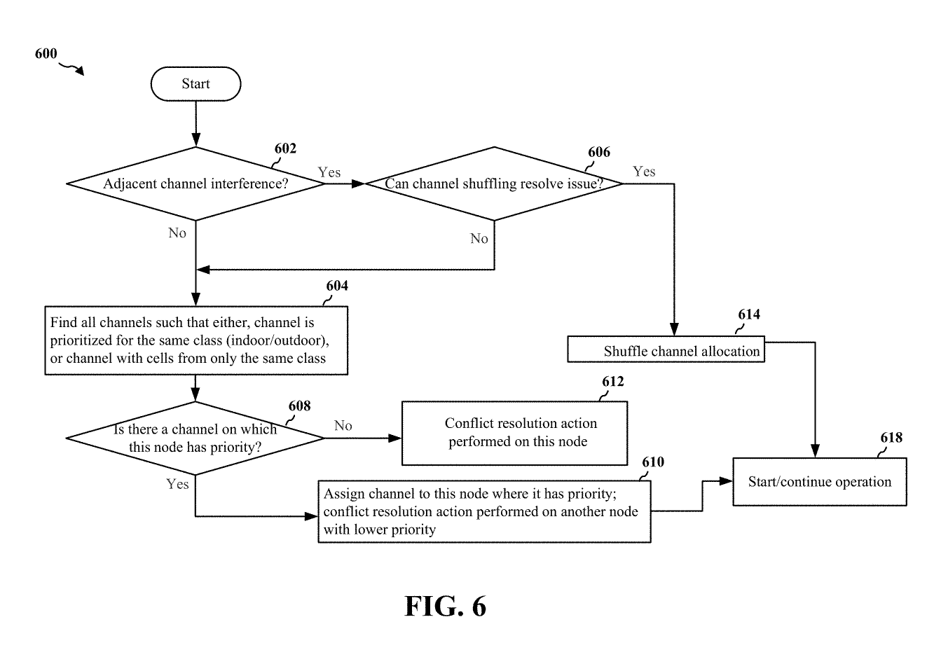

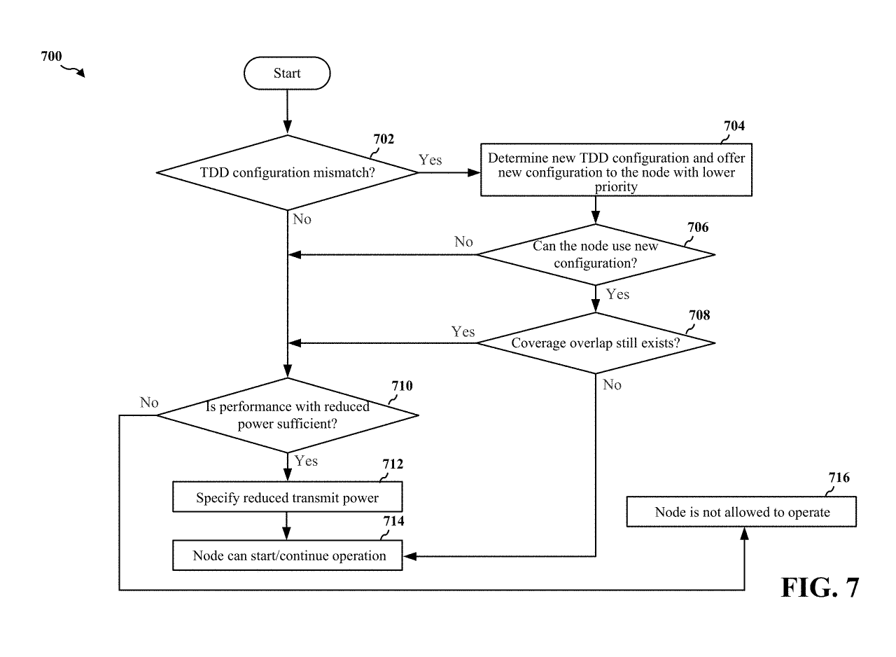

At 508, the method may perform conflict resolution. The details of the operations performed at 508 will be further described below with reference to FIGS. 6 and 7.

At 514, the method may start to operate the new node using the assigned channel.

FIG. 6 is a flowchart 600 of a method of wireless communication. Specifically, the flowchart 600 describes a method of performing conflict resolution. In one configuration, the flowchart 600 may described operations performed at 508 of FIG. 5. In one configuration, the method may be performed by an eNB (e.g., the eNB 102, 310, or the apparatus 1002/1002′). In one configuration, this method may be performed by one of the nodes in conflict. In one configuration, the method may be performed by a central entity such as SAS or Coexistence Manager. In one configuration, the method may be performed in a distributed manner.

At 602, the method may determine whether the cause of conflict is adjacent channel interference. If the cause of conflict is adjacent channel interference, the method may proceed to 606. If the cause of conflict is not adjacent channel interference, the method may proceed to 604.

At 606, the method may determine whether channel shuffling can resolve the conflict caused by adjacent channel interference. If channel shuffling can resolve the issue, the method may proceed to 614. If channel shuffling cannot resolve the issue, the method may proceed to 604.

At 604, the method may find all channels such that each channel is either prioritized for the same class (e.g., indoor/outdoor) or is with cells from the same class (e.g., LTE/MulteFire).

At 608, the method may determines whether there is a channel on which a node in conflict has priority. If there is a channel on which this node has priority, the method may proceed to 610. If there is no channel on which this node has priority, the method may proceed to 612.

At 610, the method may assign the channel to the node on which the node has priority, and perform conflict resolution actions on another node with lower priority.

At 612, the method may perform conflict resolution actions on this node.

At 614, the method may shuffle channel allocation (e.g., as described below in FIG. 7).

At 618, the method may start or continue operation for the nodes in conflict.

FIG. 7 is a flowchart 700 of a method of wireless communication. Specifically, the flowchart 700 describes conflict resolution actions performed on a node. In one configuration, the flowchart 700 may described operations performed at 610 or 612 of FIG. 6. In one configuration, the method may be performed by an eNB (e.g., the eNB 102, 310, or the apparatus 1002/1002′). In one configuration, the method may be performed by one of the nodes in conflict. In one configuration, the method may be performed by a central entity such as SAS or Coexistence Manager. In one configuration, the method may be performed in a distributed manner.

At 702, the method may determine whether there is a TDD configuration mismatch. If there is a TDD configuration mismatch, the method may proceed to 704. If there is no TDD configuration mismatch, the method may proceed to 710.

At 704, the method may determine a new TDD configuration and offer the new configuration to the node with lower priority.

At 706, the method may determine whether the node with lower priority can use the new TDD configuration. If the node can use the new TDD configuration, the method may proceed to 708. If the node cannot use the new TDD configuration, the method may proceed to 710.

At 708, the method may determine whether the coverage overlap still exists after the new TDD configuration is used by the node with lower priority. If the coverage overlap still exists, the method may proceed to 710. If the coverage overlap is resolved, the method may proceed to 714.

At 710, the method may determine whether performance with reduced transmit power will be sufficient for the node with lower priority. If the performance with reduced transmit power will be sufficient, the method may proceed to 712. If the performance with reduced transmit power will not be sufficient, the method may proceed to 716.

At 712, the method may specify reduced transmit power for the node with lower priority.

At 714, the method may start/continue operation for the node with reduced transmit power.

At 716, the method may disallow the node with lower priority to operate on the channel with the conflict.

In one configuration, conflict between two nodes may be determined based on potential overlap based on: co-channel or adjacent channel interference, eNB (network listening) and UE measurements, location information for nodes, or the retransmission rate for one or more UEs collected at one of the nodes. In one configuration, the determined conflict may be classified based on: estimated/measured interference, TDD configuration misalignment, location of nodes, technology (e.g., LTE, MulteFire), indoor or outdoor operation, or classification of channels of operation (e.g., indoor/outdoor preferred, LTE/MulteFire preferred)

In one configuration, preferences may be assigned to channels based on the number and locations of nodes with different capabilities, load on the different nodes, RF measurements, and/or number of available channels. In one configuration, preferences may be re-assigned dynamically.

In one configuration, the node for performing conflict resolution action may be determined and one of the conflict resolution actions may be performed based on a determined classification. The conflict resolution actions may include channel re-assignment, providing new TDD timing/configuration, providing lower transmit power limit, and stopping operation of the node.

In one configuration, channels may be declared as outdoor or indoor preferred to prioritize, for any given channel, operations of one node over the other. In case of a conflict, onus may be on the lower priority node to act and resolve the conflict to allow its operation. In one configuration, channels may be declared as LTE or MulteFire preferred to prioritize, for any given channel, operations of one node over the other.

In one configuration, the definition of overlap (for nodes to be in conflict) may be extended to include eNB DL to eNB UL interference and UE UL to UE DL interference. In one configuration, re-shuffling (or re-assignment) of channel preferences as indoor or outdoor, LTE or MulteFire, etc. may be performed to accommodate operation of a new node.

The methods described above with references to FIGS. 5-7 may be implemented in either centralized or distributed manner. In centralized implementation, all the relevant information, e.g., eNB (network listen) and UE measurements, location information, may be assumed to be known to the central entity. The central entity may be a Spectrum Access System (SAS) or Coexistence Manager. In one configuration, the central entity may be an eNB.

In a distributed implementation, the decisions (coexistence resolution actions) may be taken in a distributed manner. For example, a decision to reduce transmit power, change channel, change TDD configuration may be performed at an eNB instead of a central entity.

There may be two sources of inputs for decisions. The first source of input may be a central entity, which can help with coordination between nodes, e.g., by indicating that a node is in conflict with another neighboring node. The central entity may be needed because in some cases a node may not be able to determine that it is causing performance degradation to a neighboring node. In one configuration, the central entity may provide a channel preference for each channel (e.g., indoor or outdoor).

The second source of input may be a neighboring node, which may provide information using signaling defined between nodes. In one configuration, a node may utilize signaling to provide bandwidth used, wireless link load, number of active UEs, received signal and interference levels (at eNB and UE), location (indoor/outdoor), TDD configuration, transmit power, and/or capability (LTE/MulteFire) to its neighboring node. In one configuration, a node may utilize signaling to provide indication to a neighboring node with which the node has a conflict. Such an indication may be useful since conflict between two nodes may not be detectable in a symmetric manner, e.g., only one of the nodes may be able to detect the conflict. Signaling may include messages over both backhaul (e.g., X2 based) or over the air (OTA), e.g., information in SIBs.

With 3.5 GHz GAA deployment, multiple operators may share multiple channels with each other. Selecting a channel that ensures coverage while minimizing interference may be important, but cannot be defined from typical metrics. Determining coverage metrics that provide good enough coverage may be critical to both channel selection and co-existence. In one configuration, a decision regarding the existence of coverage overlap may be made without additional measurements.

In TDD-LTE, DL coverage may be predominantly limited by PDCCH. All nodes may be time aligned, thus subject to maximum interference. Channel coding may be limited by aggregation level. PDCCH reliability may be inferred at the eNB, thus making the eNB a good candidate for coverage evaluation. If the PDCCH is not decoded at the UE, the UE would not be able to decode the PDSCH, thus not being able to acknowledge the data. PDSCH retransmission may be considered as the metric for PDCCH reliability. For other channels, redundancy or orthogonalization, e.g. through inter-cell interference coordination (ICIC), may improve the demodulation performance.

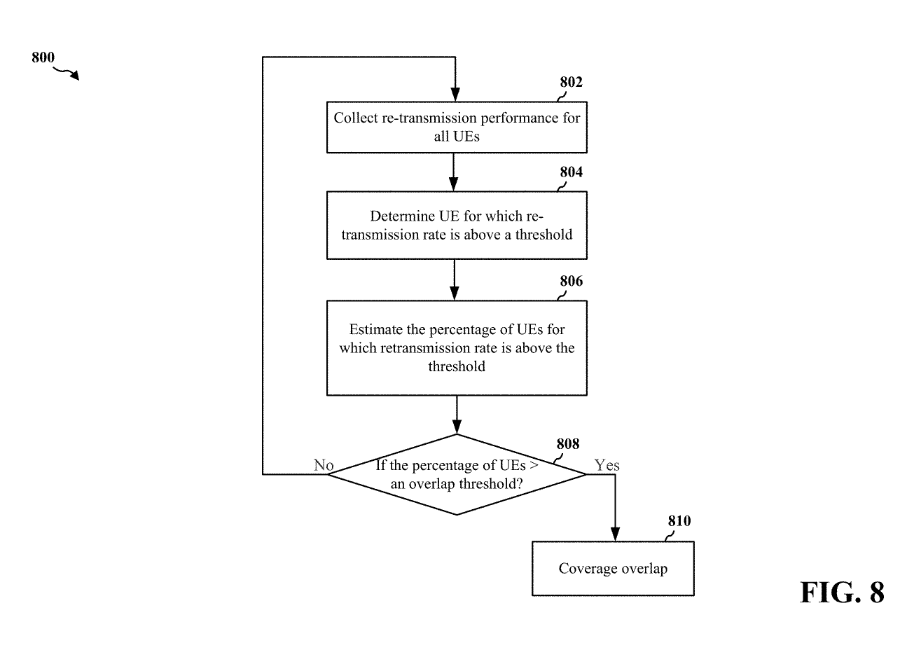

FIG. 8 is a flowchart 800 of a method of wireless communication. Specifically, the flowchart 800 describes estimating coverage overlap based on the retransmission rate for one or more UEs collected at a node. In one configuration, the method may be performed by an eNB (e.g., the eNB 102, 310, or the apparatus 1002/1002′). In one configuration, this method may be performed by one of the nodes in conflict.

At 802, the eNB may collect retransmission performance statistics for all UEs that are served by the eNB. In one configuration, the eNB may receive reports including the retransmission performance statistics from the UEs.

At 804, the eNB may determine one or more UEs for which retransmission rate is above a threshold. In one configuration, the threshold may be 20%.

At 806, the eNB may estimate the percentage of UEs for which retransmission rate is above the threshold. For example, if there are 10 UEs served by the eNB and 3 of the 10 UEs have retransmission rate that is above the threshold, the percentage would be 30%.

At 808, the eNB may determine whether the percentage of UEs estimated at 806 is greater than an overlap threshold. In one configuration, the overlap threshold may be a percentage between 5-10%. If the percentage of UEs is greater than the overlap threshold, the eNB may proceed to 810. If the percentage of UEs is less than or equal to the overlap threshold, the eNB may loop back to 802 to collect updated retransmission performance statistics.

At 810, the eNB may determine that there is coverage overlap.

In one configuration, the method evaluation may run constantly. For each UE, the method may accumulate the retransmission statistics for the UE. The method may estimate the percentage of UEs for which retransmission statistics are above a defined threshold. In one configuration, the threshold may be 20%. In one configuration, the coverage overlap evaluation may run periodically. If the percentage of UEs for which retransmission statistics are above a defined threshold is above a defined overlap threshold (e.g., a percentage between 5%-10%), the cell may be declared as having overlap.

In one configuration, coverage overlap may be estimated based on UE performance within the cell. There is no need to get measurements from other cells or neighboring cells. Evaluation may be done irrespective of the other/overlapping cell. For example, evaluation may be done irrespective of cells with different technology, cells with different configurations (TDD frame configuration or time offset), or different/adjacent channels.

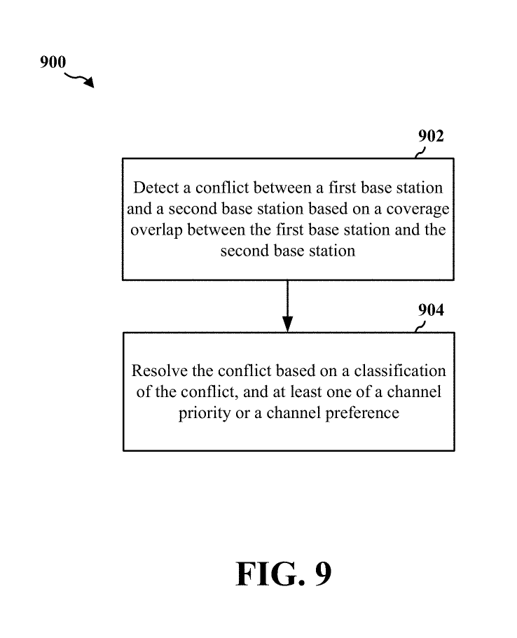

FIG. 9 is a flowchart 900 of a method of wireless communication. Specifically, the flowchart 900 describes a coexistence solution for sharing channels. In one configuration, the flowchart 900 may described operations performed in FIGS. 5-8. In one configuration, the method may be performed by an eNB (e.g., the eNB 102, 310, or the apparatus 1002/1002′). In one configuration, the method may be performed by one of the nodes in conflict. In one configuration, the method may be performed by a central entity such as SAS or Coexistence Manager. In one configuration, the method may be performed in a distributed manner.

At 902, the method may detect a conflict between a first base station and a second base station based on a coverage overlap between the first base station and the second base station. In one configuration, the coverage overlap may be determined based on a co-channel interference or adjacent channel interference between the first base station and the second base station. In one configuration, the coverage overlap may be determined based on at least one of measurements at the first base station, measurements at the second base station, or measurements at a UE that is served by the first base station or the second base station. In one configuration, the coverage overlap may be determined based on eNB to eNB interference and UE to UE interference. In one configuration, the coverage overlap may be determined based on location information of the first base station and the second base station. In one configuration, the coverage overlap may be estimated based on a retransmission rate for one or more UEs collected at the first base station or the second base station.

At 904, the method may resolve the conflict based on a classification of the conflict, and at least one of a channel priority or a channel preference. In one configuration, the classification of the conflict may be a co-channel conflict or an adjacent channel conflict. In one configuration, when the conflict is the adjacent channel conflict, the resolving of the conflict may include reshuffling the channel allocation.

In one configuration, the resolving of the conflict may include: selecting a candidate base station from the first base station and the second base station based on at least one of the channel priority or the channel preference; and adjusting the candidate base station to resolve the conflict. The candidate base station may be a base station with lower priority. In one configuration, the adjusting of the candidate base station may include changing TDD configuration of the candidate base station. In one configuration, the adjusting of the candidate base station may include reducing transmit power of the candidate base station. In one configuration, the adjusting of the candidate base station may include changing the operating channel of the candidate base station.

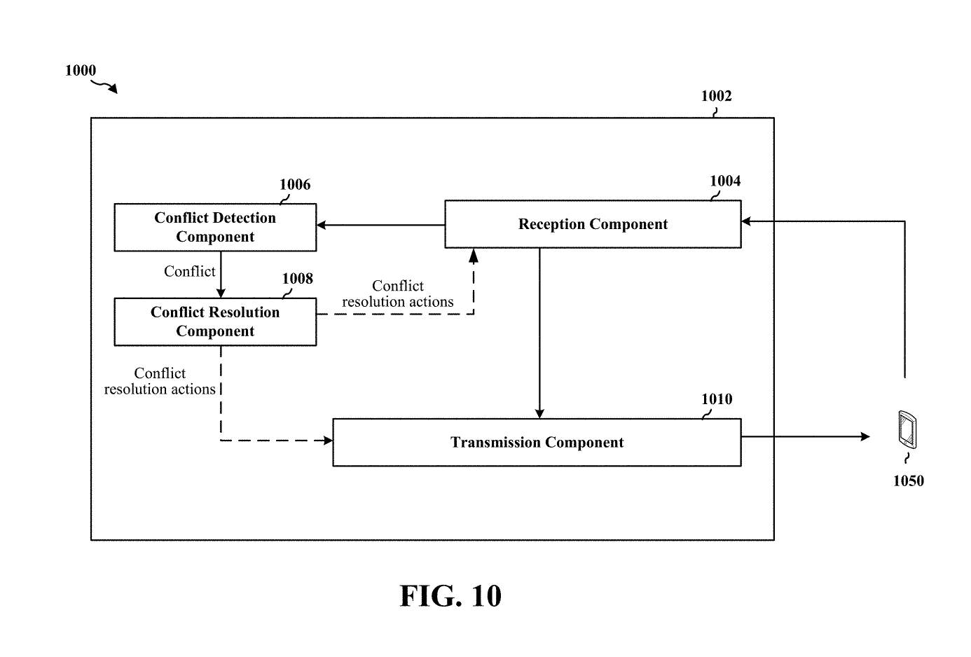

FIG. 10 is a conceptual data flow diagram 1000 illustrating the data flow between different means/components in an exemplary apparatus 1002. The apparatus 1002 may be an eNB. The apparatus 1002 may include a reception component 1004 that receives information from a UE 1050. The apparatus 1002 may include a transmission component 1010 that transmits information to the UE 1050. The reception component 1004 and the transmission component 1010 may work together to coordinate the communication of the apparatus 1002.

The apparatus 1002 may include a conflict detection component 1006 that detects a conflict between two nodes based on the coverage overlap between the two nodes. The apparatus 1002 may include a conflict resolution component 1008 that resolves the conflict detected by the conflict detection component 1006 based on a classification of the conflict, and at least one of a channel priority or a channel preference.

The apparatus may include additional components that perform each of the blocks of the algorithm in the aforementioned flowcharts of FIGS. 5-9. As such, each block in the aforementioned flowcharts of FIGS. 5-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

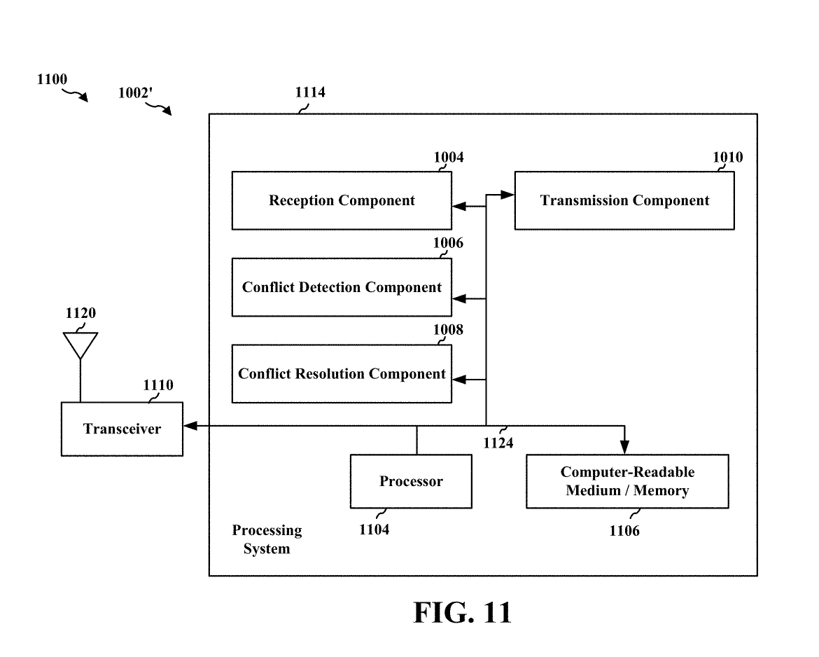

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010 and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1010, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010. The components may be software components running in the processor 1104, resident/stored in the computer readable medium/memory 1106, one or more hardware components coupled to the processor 1104, or some combination thereof. The processing system 1114 may be a component of the eNB 310 and may include the memory 376 and/or at least one of the TX processor 316, the RX processor 370, and the controller/processor 375.

In one configuration, the apparatus 1002/1002′ for wireless communication includes means for detecting a conflict between a first base station and a second base station based on a coverage overlap between the first base station and the second base station, and means for resolving the conflict based on a classification of the conflict, and at least one of a channel priority or a channel preference.

In one configuration, when the conflict is the adjacent channel conflict, the means for resolving the conflict may be configured to reshuffle a channel allocation. In one configuration, the means for resolving the conflict may be configured to: select a candidate base station from the first base station and the second base station based on at least one of the channel priority or the channel preference; and adjust the candidate base station to resolve the conflict.

The aforementioned means may be one or more of the aforementioned components of the apparatus 1002 and/or the processing system 1114 of the apparatus 1002′ configured to perform the functions recited by the aforementioned means. As described supra, the processing system 1114 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, comprising:
detecting a conflict between a first base station and a second base station based on a coverage overlap between the first base station and the second base station; and
resolving the conflict based on a classification of the conflict, and at least one of a channel priority or a channel preference.

2. The method of claim 1, wherein the coverage overlap is determined based on a co-channel interference or adjacent channel interference between the first base station and the second base station.

3. The method of claim 1, wherein the coverage overlap is determined based on at least one of measurements at the first base station, measurements at the second base station, or measurements at a UE that is served by the first base station or the second base station.

4. The method of claim 1, wherein the coverage overlap is determined based on eNB to eNB interference and UE to UE interference.

5. The method of claim 1, wherein the coverage overlap is determined based on location information of the first base station and the second base station.

6. The method of claim 1, wherein the coverage overlap is estimated based on a retransmission rate for one or more UEs collected at the first base station or the second base station.

7. The method of claim 1, wherein the classification of the conflict is a co-channel conflict or an adjacent channel conflict.

8. The method of claim 7, wherein, when the conflict is the adjacent channel conflict, the resolving of the conflict comprises reshuffling a channel allocation.

9. The method of claim 1, wherein the resolving of the conflict comprises:
selecting a candidate base station from the first base station and the second base station based on at least one of the channel priority or the channel preference; and
adjusting the candidate base station to resolve the conflict.

10. The method of claim 9, wherein the candidate base station is a base station with lower priority.

11. The method of claim 9, wherein the adjusting of the candidate base station comprises at least one of:
changing TDD configuration of the candidate base station;
reducing transmit power of the candidate base station; or
changing operating channel of the candidate base station.

12. An apparatus for wireless communication, comprising:
means for detecting a conflict between a first base station and a second base station based on a coverage overlap between the first base station and the second base station; and
means for resolving the conflict based on a classification of the conflict, and at least one of a channel priority or a channel preference.

13. The apparatus of claim 12, wherein the coverage overlap is determined based on a co-channel interference or adjacent channel interference between the first base station and the second base station.

14. The apparatus of claim 12, wherein the coverage overlap is determined based on at least one of measurements at the first base station, measurements at the second base station, or measurements at a UE that is served by the first base station or the second base station.

15. The apparatus of claim 12, wherein the classification of the conflict is a co-channel conflict or an adjacent channel conflict.

16. The apparatus of claim 15, wherein, when the conflict is the adjacent channel conflict, the means for resolving the conflict is configured to reshuffle a channel allocation.

17. The apparatus of claim 12, wherein the means for resolving the conflict is configured to:
select a candidate base station from the first base station and the second base station based on at least one of the channel priority or the channel preference; and
adjust the candidate base station to resolve the conflict.

18. The apparatus of claim 17, wherein the candidate base station is a base station with lower priority, wherein the adjusting of the candidate base station comprises at least one of:
changing TDD configuration of the candidate base station;
reducing transmit power of the candidate base station; or
changing operating channel of the candidate base station.

19. An apparatus for wireless communication, comprising:
a memory; and
at least one processor coupled to the memory and configured to:
detect a conflict between a first base station and a second base station based on a coverage overlap between the first base station and the second base station; and
resolve the conflict based on a classification of the conflict, and at least one of a channel priority or a channel preference.

20. The apparatus of claim 19, wherein the coverage overlap is determined based on a co-channel interference or adjacent channel interference between the first base station and the second base station.

21. The apparatus of claim 19, wherein the coverage overlap is determined based on at least one of measurements at the first base station, measurements at the second base station, or measurements at a UE that is served by the first base station or the second base station.

22. The apparatus of claim 19, wherein the coverage overlap is determined based on eNB to eNB interference and UE to UE interference.

23. The apparatus of claim 19, wherein the coverage overlap is determined based on location information of the first base station and the second base station.

24. The apparatus of claim 19, wherein the coverage overlap is estimated based on a retransmission rate for one or more UEs collected at the first base station or the second base station.

25. The apparatus of claim 19, wherein the classification of the conflict is a co-channel conflict or an adjacent channel conflict.

26. The apparatus of claim 25, wherein, when the conflict is the adjacent channel conflict, to resolve the conflict, the at least one processor is configured to reshuffle a channel allocation.

27. The apparatus of claim 19, wherein, to resolve the conflict, the at least one processor is configured to:
select a candidate base station from the first base station and the second base station based on at least one of the channel priority or the channel preference; and
adjust the candidate base station to resolve the conflict.

28. The apparatus of claim 27, wherein the candidate base station is a base station with lower priority.

29. The apparatus of claim 27, wherein the adjusting of the candidate base station comprises at least one of:
changing TDD configuration of the candidate base station;
reducing transmit power of the candidate base station; or
changing operating channel of the candidate base station.

30. A computer-readable medium storing computer executable code, comprising code to:
detect a conflict between a first base station and a second base station based on a coverage overlap between the first base station and the second base station; and
resolve the conflict based on a classification of the conflict, and at least one of a channel priority or a channel preference.
